(19) United States
(12) Patent Application Publication
(10) Pub. No.: US 2022/0061108 A1
(43) Pub. Date: Feb. 24, 2022

(54) EFFICIENT CELLULAR COMMUNICATION

(71) Applicant: Nordic Semiconductor ASA, Trondheim (NO)

(72) Inventors: Mauri NISSILÄ, Trondheim (NO); Hanna-Liisa TIRI, Trondheim (NO)

(73) Assignee: Nordic Semiconductor ASA, Trondheim (NO)

(21) Appl. No.: 17/413,421

(22) PCT Filed: Dec. 11, 2019
(86) PCT No.: PCT/EP2019/084719

§ 371 Date: Jun. 11, 2021

(30) Foreign Application Priority Data
Dec. 11, 2018 (GB) 1820171.5

(51) Int. Cl. H04W 76/10; H04W 68/00; H04W 74/08; H04W 4/70

(52) U.S. Cl. CPC H04W 76/10; H04W 4/70; H04W 74/0833; H04W 68/005

(57) ABSTRACT

A radio device sends a random-access request message to a base station and receives a random-access response message from the base station. A plurality of data transport blocks are thereafter transmitted in a first direction between the radio device and the base station, but the radio device does not send a connection-setup complete message to the base station until all of the plurality of data transport blocks having been transmitted.

### BACKGROUND OF THE INVENTION

This invention relates to radio devices, radio system, and methods and software for operating the same.

It is known for cellular radio user equipment, such as a cell phone or other radio device, to initiate a connection-establishment process to establish an active connection with a particular base station. It may do so of its own initiative, or it may do so in response to a paging message received from the base station. To establish a connection, the user equipment and the base station may perform a random-access procedure, followed by a connection-establishment procedure. The user equipment may send a connection-establishment request message to the base station after receiving a random-access response message from the base station. The user equipment may subsequently send a connection-setup complete message to the base station to indicate that it has now entered a connected state.

For example, in the 3rd generation partnership project (3GPP) Long Term Evolution (LTE) wireless communication standard, user equipment (UE) may send a Radio Resource Control (RRC) Connection Request to an Evolved Node B (eNodeB), after receiving a Random Access Response (RAR) message from the eNodeB. This request will then be followed subsequently by a RRC Connection Complete message when the UE transitions from an idle state (RRC_IDLE) to a connected state (RRC_CONNECTED). In the connected state, the UE can feely communicate with the serving eNodeB using a signalling radio bearer (SRB).

Once an RRC connection is established (i.e., the UE has entered the connected state and sent a RRC Connection Complete message), whenever the UE has data to send to the network it can initiate a Service Request procedure to request appropriate user-plane radio resources.

However, establishing an RRC connection consumes significant electrical power. This can be problematic, especially for machine-to-machine (M2M) devices, such as wireless sensors, which may have limited battery capacity.

It has therefore been proposed to allow UE's to include a small amount of up-link (UL) data in the connection-establishment request message. The network, on receiving this data, can then signal the UE to remain in an idle state, rather than completing the connection establishment process. The UE therefore remains idle and does not send a corresponding RRC connection complete message. This allows the UE to send a data block (e.g., containing sensor readings) without expending the additional power required to transition from the idle state to a connected state.

Such an approach is beneficial. However, the present inventors have recognised that it has certain limitations and can be improved upon.

### SUMMARY OF THE INVENTION

From a first aspect, the invention provides a method of operating a radio system comprising a radio device and a base station, wherein the radio system is configured for establishing a data connection between the radio device and the base station by performing steps comprising the radio device: sending a random-access request message to the base station; receiving a random-access response message from the base station; sending a connection-establishment request message to the base station; and sending a connection-setup complete message to the base station, the method comprising:
the radio device sending a random-access request message to the base station;
the radio device receiving a random-access response message from the base station; and
thereafter transmitting a plurality of data transport blocks in a first direction between the radio device and the base station, wherein the radio device does not send a connection-setup complete message to the base station between i) receiving the random-access response message and ii) all of the plurality of data transport blocks having been transmitted.

From a second aspect, the invention provides a radio system comprising a radio device and a base station, wherein:
the radio system is configured for establishing a data connection between the radio device and the base station by performing steps comprising the radio device: sending a random-access request message to the base station; receiving a random-access response message from the base station; sending a connection-establishment request message to the base station; and sending a connection-setup complete message to the base station; and
the radio system is further configured for transmitting a plurality of data transport blocks in a first direction between the radio device and the base station by performing steps comprising: the radio device sending a random-access request message to the base station; the radio device receiving a random-access response message from the base station; and, thereafter, transmitting the plurality of data transport blocks in the first direction between the radio device and the base station, wherein the radio device does not send a connection-setup complete message to the base station between i) receiving the random-access response message and ii) all of the plurality of data transport blocks having been transmitted.

From a third aspect, the invention provides a radio device for communicating with a radio system comprising a base station, wherein:
the radio device is configured for establishing a data connection with the base station by performing steps comprising the radio device: sending a random-access request message to the base station; receiving a random-access response message from the base station; sending a connection-establishment request message to the base station; and sending a connection-setup complete message to the base station; and
the radio device is further configured for transmitting a plurality of data transport blocks to the base station, or for receiving a plurality of data transport blocks from the base station, by performing steps comprising: sending a random-access request message to the base station; receiving a random-access response message from the base station; and, thereafter, transmitting or receiving the plurality of data transport blocks, wherein the radio device does not send a connection-setup complete message to the base station between i) receiving the random-access response message and ii) transmitting or receiving all of the plurality of data transport blocks.

Thus it will be seen that, in accordance with the invention, the radio device can exchange a quantity of data with the base station that is too large to fit within a single data transport block, yet still without needing to complete a full connection setup process. This enables the radio device to send or receive more data than was previously possible, while still remaining in an idle (i.e. disconnected) state, thereby saving power.

The plurality of data transport blocks may contain respective pieces from a single data source, such as a single data file. The radio device may be configured to split a source data file or stream across the plurality of data transport blocks, or to combine data from the data transport blocks into a single output data file or stream.

In some situations, the radio device may use this early data transmission mechanism in combination with requesting a connection establishment. However, in preferred embodiments of the method, the radio device also does not send a connection-establishment request message to the base station between i) receiving the random-access response message and ii) all of the plurality of data transport blocks having been transmitted. In this case, the transaction may terminate immediately after all of the plurality of data transport blocks having been transmitted. The radio device may remain in an idle state while all of the plurality of data transport blocks are transmitted.

The random-access messages may form part of a contention-based random-access process, or may be contention-free. In some embodiments, the random-access response message may contain radio-device identification data.

The random-access response message may contain scheduling information for one or more, or all, of the plurality of data transport blocks.

Some or all of the plurality of data transport blocks may be scheduled at predetermined intervals, which may be preconfigured in the radio device and the base station (e.g., stored in a memory of each device). The intervals may have a common duration, or may conform to a predetermined pattern. The same predetermined intervals may be used for a plurality of transactions. This reduces the amount of scheduling information to be exchanged between the base station and the radio device. However, in some embodiments, the plurality of blocks may be scheduled at least partly, or solely, according to scheduling information that is communicated between the radio device and the base station—e.g., encoded in the random-access response message and/or one or more downlink control indicator messages.

The plurality of data transport blocks may be transmitted from the radio device to the base station. A first block of the plurality of data transport blocks may be the first block to be transmitted by the radio device after the radio device receives the random-access response message. This first block may additionally contain radio-device identification data—e.g., derived from data contained in the random-access response message. Alternatively, the radio device may send a message in response to the random-access response message that is separate from the plurality of data transport blocks.

In embodiments where the data transport blocks are transmitted by the radio device, the radio device may communicate to the base station information representing how much data (e.g., how many data transport blocks), it will transmit in the plurality of data transport blocks. The information may be encoded in a first message sent by the radio device after it receives the random-access response message.

The plurality of data transport blocks may consist of two, three, ten, a hundred or more blocks.

The radio device may be configured to determine a quantity of data to send to the base station and to determine, based on the quantity of data, whether to establish a data connection with the base station (e.g., if the quantity of data exceeds a threshold) or whether to send the data in one or more data transport blocks without sending a connection-establishment request message to the base station (e.g., if the quantity of data is below the threshold). The radio device may further determine whether to send a single data transport block (e.g., if the quantity of data is below a maximum transport block size) or whether to transmit a plurality of data transport blocks.

The base station may be similarly configured to determine how the data will be sent, based on information received from the radio device relating to the quantity of data to be transmitted.

The radio device may be configured to use common transmission parameters and/or common allocation information when sending each of the data transport blocks, unless the radio device receives downlink control information from the base station while transmitting the plurality of data transport blocks.

In embodiments where the data transport blocks are received by the radio device, the radio device may send a respective acknowledgement message for each block.

In some embodiments, one or more further data transport blocks may be sent in a second, opposite direction, after the radio device receives the random-access response message from the base station, but before any connection-setup complete message is sent to the base station.

The radio device may send the random-access request message to the base station in response to an internal or external action on the radio device—e.g., a user action.

Alternatively, the radio device may send the random-access request message in response to receiving a paging message from the base station.

The applicant has recognised that this enables a further advantage compared with conventional approaches, in that the base station can initiate a data transfer to the radio device without a full data connection having to be established. While this may be used to transmit data spanning multiple transport blocks, the applicant has recognised that it may be beneficial even for down-link data amounts that are less than the maximum transport block size.

Thus, from a further aspect, the invention provides a method of operating a radio system comprising a radio device and a base station, wherein the radio system is configured for establishing a data connection between the radio device and the base station by performing steps comprising the radio device: sending a random-access request message to the base station; receiving a random-access response message from the base station; sending a connection-establishment request message to the base station; and sending a connection-setup complete message to the base station, the method comprising:
the base station sending a paging message to the radio device;
the radio device, in response to the paging message, sending a random-access request message to the base station;
the radio device receiving a random-access response message from the base station; and
the base station thereafter transmitting one or more data transport blocks to the radio device,
   wherein the radio device does not send a connection-setup complete message to the base station between i) receiving the random-access response message and ii) receiving all of the one or more data transport blocks.

From another aspect, the invention provides a radio system comprising a radio device and a base station, wherein:
the radio system is configured for establishing a data connection between the radio device and the base station by performing steps comprising the radio device: sending a random-access request message to the base station; receiving a random-access response message from the base station; sending a connection-establishment request message to the base station; and sending a connection-setup complete message to the base station; and

the radio system is further configured for transmitting one or more data transport blocks from the base station to the radio device by performing steps comprising: the base station sending a paging message to the radio device; the radio device, in response to the paging message, sending a random-access request message to the base station; the radio device receiving a random-access response message from the base station; and the base station thereafter transmitting the one or more data transport blocks to the radio device, wherein the radio device does not send a connection-setup complete message to the base station between i) receiving the random-access response message and ii) receiving all of the one or more of data transport blocks.

From another aspect, the invention provides a radio device for communicating with a radio system comprising a base station, wherein:
the radio device is configured for establishing a data connection with the base station by performing steps comprising the radio device: sending a random-access request message to the base station; receiving a random-access response message from the base station; sending a connection-establishment request message to the base station; and sending a connection-setup complete message to the base station; and
the radio device is further configured for receiving one or more data transport blocks from the base station by performing steps comprising: receiving a paging message from the base station; sending, in response to the paging message, a random-access request message to the base station; receiving a random-access response message from the base station; and, thereafter, receiving the one or more data transport blocks from the base station, wherein the radio device does not send a connection-setup complete message to the base station between i) receiving the random-access response message and ii) receiving all of the one or more of data transport blocks.

Any features of the earlier aspects and embodiments may be features of embodiments of these aspects also, and vice versa.

The paging message may be a conventional paging message, such as a paging message defined in 3GPP Release 15 or earlier, or it may be a novel type of paging message that instructs the radio device to monitor for the one or more data transport blocks. Alternatively, or additionally, the random-access response message and/or a downlink control indicator message sent by the base station may instruct the radio device to prepare to receive the one or more data transport blocks.

The base station may transmit a plurality of data transport blocks to the radio device, wherein the radio device does not send a connection-setup complete message to the base station between i) receiving the random-access response message and ii) receiving all of the plurality of data transport blocks.

In any of the aspects disclosed herein, the base station may be a base station of a radio access network. The radio access network may comprise a plurality of base stations. It may be a packet-switched cellular telecommunications data network. It may support a version of the 3GPP LTE (Long Term Evolution) standard. The base station may be a 3GPP evolved Node B (eNodeB) base station.

The radio device may use any standard or proprietary radio protocol to communicate with the base station. In one set of embodiments, the radio device implements a version of the 3GPP LTE (Long Term Evolution) standard. The radio device may be a cell phone or other human communication device. However, in a preferred set of embodiments, it is a non-voice communication device, such as a machine-to-machine (M2M) device—e.g., a wireless sensor or controller. It may implement a Machine-Type Communications (MTC) radio protocol such as LTE Cat-M1 or Narrowband Internet-of-Things (NB-IoT).

The random-access request message may be a 3GPP Random-Access message. The random-access response message may be a 3GPP Random-Access Response (RAR) message. The connection-establishment request message may be a 3GPP Radio Resource Control (RRC) Connection Request (RACH Msg3). The connection-setup complete message may be a 3GPP RRC Connection Setup Complete message.

The radio device may comprise any one or more of: processors, memory for storing software instructions, memory having software instructions stored therein, digital logic, analogue circuitry, DSPs, power supplies, user interfaces, sensors, etc. It may be, or may comprise, an integrated-circuit radio-on-a-chip. The functions described herein may be implemented entirely in hardware, or entirely in software, or by a combination of hardware and software, in any appropriate mixture.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain preferred embodiments of the invention will now be described, by way of example only, with reference to the accompanying drawings, in which:

FIG. 1 is a schematic diagram illustrating a typical LTE network embodying the invention;

FIG. 2 is a schematic diagram of a wireless temperature sensor device embodying the invention;

FIG. 3 is a protocol sequence diagram showing establishing a connection between a UE and an eNodeB according to embodiments of the invention;

FIG. 4 is a protocol sequence diagram showing multiple up-link data blocks being sent to an eNodeB according to embodiments of the invention;

FIG. 5 is a protocol sequence diagram showing a novel paging message being used to send multiple down-link data blocks from an eNodeB according to embodiments of the invention;

FIG. 6 is a protocol sequence diagram showing a novel DCI or RAR message being used to send multiple down-link data blocks from an eNodeB according to embodiments of the invention; and

FIG. 7 is a protocol sequence diagram showing a novel Contention Resolution message being used to send multiple down-link data blocks from an eNodeB according to embodiments of the invention.

### DETAILED DESCRIPTION

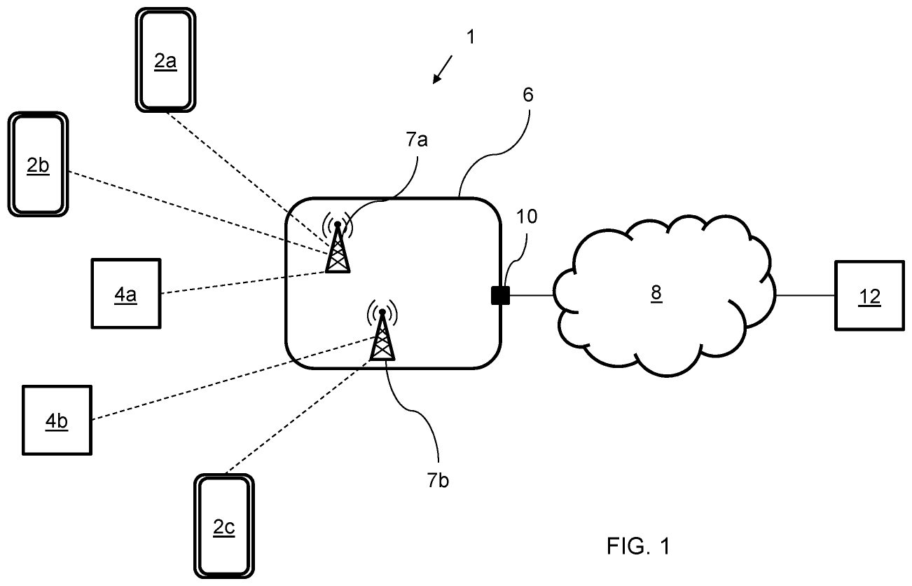

FIG. 1 is a schematic diagram illustrating a typical LTE system 1 suitable for implementing the invention as disclosed above. The system 1 includes a number of user equipment (UE) devices, such as LTE-enabled smartphones 2a, 2b, 2c and other LTE M2M devices 4a, 4b, which are arranged to communicate with a cellular telecommunications data network 6 via a number of LTE eNodeB's 7a, 7b. These UE devices 2, 4 may be electronic devices embodying the invention. The cellular telecommunications network 6 (e.g., comprising an Evolved Universal Mobile Telecommunications System (UMTS) Terrestrial Radio Access Network (E-UTRAN) and an Enhanced Packet Core (EPC) network) is connected to the Internet 8 via a gateway 10. An illustrative remote server 12 is shown connected to the Internet 8; this could be connected by a further LTE network or by some other means (e.g., a wired ISP network).

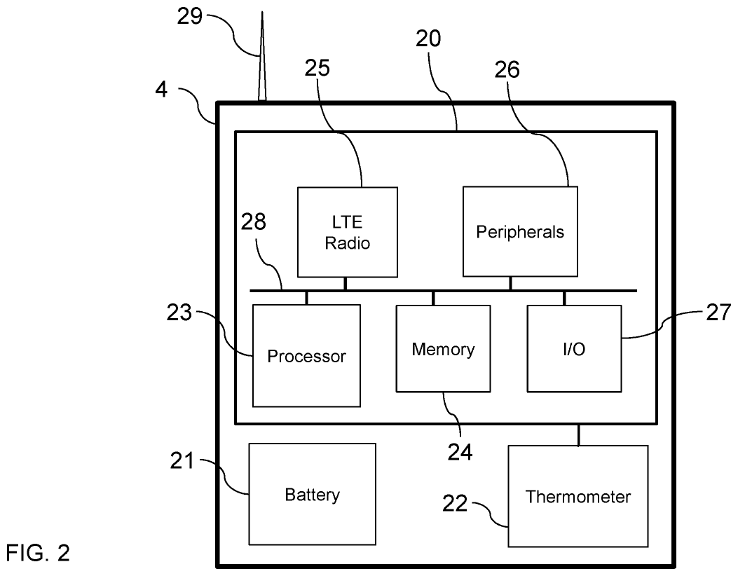

FIG. 2 provides more detail of an exemplary M2M device 4 embodying the invention. It shows a wireless temperature sensor 4 which contains an integrated-circuit radio-on-a-chip 20, a battery 21 and a thermometer module 22. It will be appreciated that the sensor device 4 may also contain other discrete components, such as PCBs, oscillators, capacitors, resistors, a housing, user interface features, etc. which are not shown in FIG. 2 for the sake of simplicity.

The radio chip 20 contains a processor 23, memory 24 (which may include volatile and non-volatile memory types), an LTE Cat-M1 (LTE-M) radio 25, general peripherals 26 (which may include a hardware cryptography engine, digital-to-analogue converters, timers, etc.) and input/output peripherals 27 (e.g., a USB interface). These elements are all connected to a bus system 28 (e.g., compliant with the Arm™ Advanced Microcontroller Bus Architecture) which supports direct memory access (DMA) to the memory-mapped peripherals 26, 27. In one example, the processor 23 is an Arm™ Cortex™-M series processor, although it could be any type of processor.

The LTE-M radio 25 contains digital and analogue logic; in some embodiments, the radio 25 may contain a further general-purpose processor (not shown), such as a further ARM™ core, for implementing some of all of the LTE-M radio protocol and the novel techniques discloses herein at least partly in software. The LTE-M radio 25 and/or radio chip 20 may contain other conventional components, such as DSPs, amplifiers, etc. The temperature sensor 4 also has an antenna 29 which is connected to the LTE-M radio 25 via appropriate off-chip components (not shown).

The memory 24 stores software which is executed by the processor 23 for controlling the operation of the wireless temperature sensor 4.

In use, the processor 23 uses the I/O peripherals 27 to fetch temperature readings from the thermometer module 22 at intervals (e.g., every 15 minutes), and writes these to the memory 24. The processor 23 uses the LTE radio 25 to send a log of temperature readings to a remote server 12 over the Internet 6 at intervals (e.g., hourly, or daily). It is desirable for the LTE radio 25 to remain in a lower-power state for as much of the time as possible in order to prolong the life of the battery 21. The LTE radio 25 may support the LTE-Cat M1 (LTE-M) and/or Narrowband Internet-of-Things

(NB-IoT) protocols and may use one of these (in any current or future specification) for communicating with the radio access network 6.

When the LTE radio 25 has data to send over the network 6, it could potentially switch from an RRC_IDLE state to an RRC_CONNECTED state and send the up-link (mobile-originating) data over a Data Radio Bearer (DRB) established using the conventional LTE Radio Resource Control (RRC) connection or re-connection protocol.

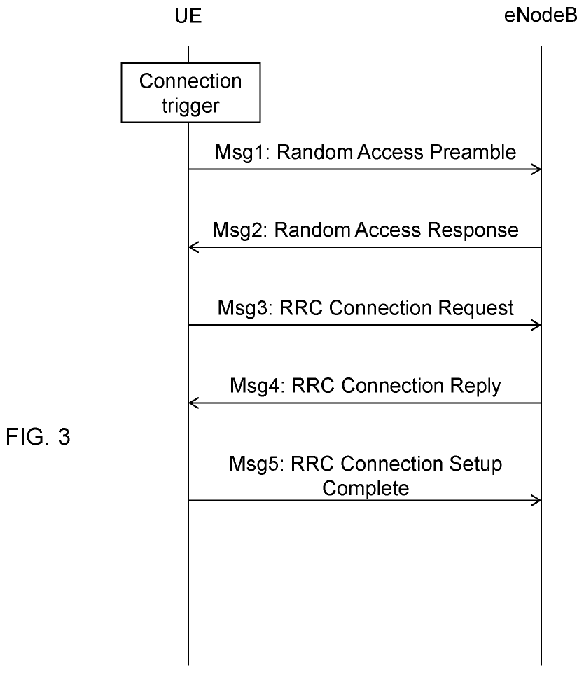

FIG. 3 illustrates such an approach. When the need for a connection is triggered on the radio 25, the sensor 4 may first send a conventional random-access preamble message (Msg1) to a nearby eNodeB 7. The eNodeB 7 responds with a conventional random-access response message (Msg2). The sensor 4 then sends a conventional RRC connection request message (Msg3), to which the eNodeB 7 responds with an RRC connection ready message (Msg4). The radio 25 then switches to the RRC_CONNECTED state and requests resources to send an RRC connection setup complete message (Msg5) to the eNodeB 7. Not shown in FIG. 3, for the sake of simplicity, are the various control channel (PDCCH, PUCCH and PHICH) messages that may be interleaved with the depicted messages, for requesting and receiving resource assignments, and for sending acknowledgements.

The sensor 4 may use this approach for sending data over the radio access network 6, and could do so when it has to carry out a complex interaction with the remote server 12, such as negotiating a firmware upgrade. However, when it is sending routine logged data, or when receiving routine data from the server 12, it saves power by instead using one or more of the novel methods disclosed herein for communicating up-link and/or down-link data.

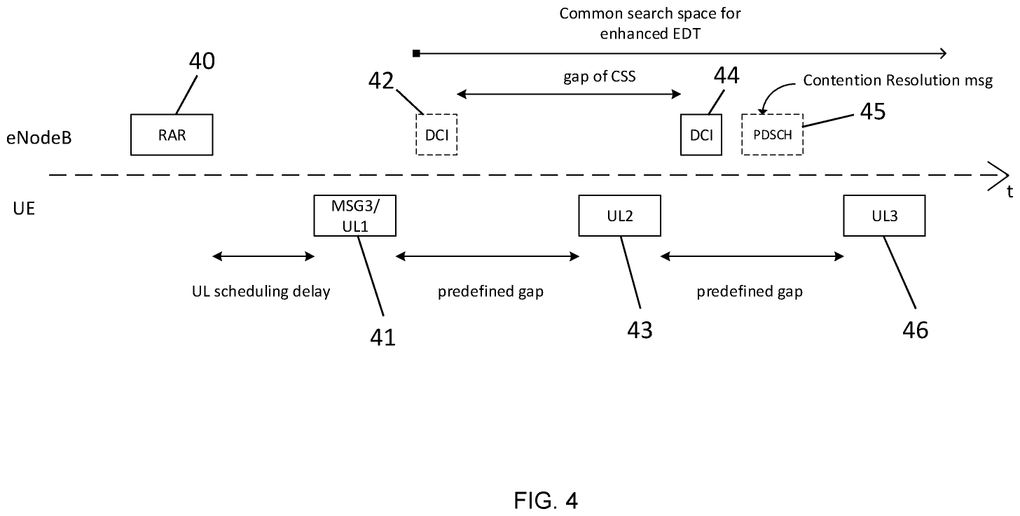

FIG. 4 illustrates a method that the sensor 4 can use when it has up-link (UL) data to send over the radio network 6.

In each of FIGS. 4 to 7, significant messages sent by the sensor 4 are shown in the “UE” section, below the time axis, while significant messages sent by the eNodeB (eNB) 7 are shown in the “eNodeB” section, above the time axis. Other messages (not shown) may also be exchanged over the depicted time period.

FIG. 4 shows a situation in which the sensor 4 has to send log data that exceeds the maximum transport block size (TBS), so which cannot fit in a single up-link block, but which is less than a maximum limit set for the present method (which will be referred to herein as enhanced Early Data Transmission, or enhanced-EDT).

A novel Msg3 message encodes the amount of up-link data the sensor 4 intends to transmit. If the log data is less than the maximum TBS, then the sensor 4 uses the Early Data Transmission (EDT) mechanism described in 3GPP Release 15 to send the data in a single up-link block. If the log data is greater than the maximum enhanced-EDT limit, then a full RRC connection is established for sending the log data over a data bearer, as described above. By encoding the length in the Msg3, the eNodeB 7 can determine which mechanism to use for receiving the data from the sensor 4.

In FIG. 4, the sensor 4 has already sent a random access request message (not shown) as in FIG. 3. The eNB 7 responds with a random access response (RAR) 40.

The RAR 40 provides UL grant for the UE (sensor 4) with the maximum TBS provided by the System Information Block (SIB). In addition, the eNB pre-allocates a number of additional resource blocks with predefined gap(s) between consecutive transmission opportunities. In alternative embodiments, the eNB pre-allocates a number of additional resource blocks with a predefined pattern—for example, a pattern of N consecutive resource blocks, followed by a predefined gap, which is repeated M times or until the UE indicates the end of the data transmission.

After receiving the RAR 40, the UE will transmit mobile-originating (MO) data according to the following:
if the MO data size is equal or less than the max TBS, the UE will deliver data encapsulated in Msg3, according to principles specified in 3GPP Release 15
if, as in this example, the MO data size exceeds the max TBS, the MO data is segmented into number of transport blocks and the first transport block is transmitted in Msg3 as scheduled by the RAR 40.

Thus, after a scheduling delay, the sensor 4 sends a novel “enhanced-EDT” Msg3 request message 41, which may include a first block of the up-link data (UL1) and an indication that the UE wants to continue the data transmission using the pre-defined UL resources. In addition, the UE may indicate the total length of data the sensor 4 intends to send. The total length of data may be indicated as a Buffer Status Report (BSR), or as a maximum number of resource blocks the UE will need for the transmission of its data.

The additional transport blocks (TBs) are transmitted using the additional transmission opportunities associated with the RAR 40. The additional transmission opportunities (i.e. the pre-defined UL resources) may be configured in the RAR message 40 or by using RRC signalling while the UE is in the RRC Connected state.

In the Msg3 41 (i.e., the first message transmitted by the UE after the RAR 40), the UE will indicate how many transmission opportunities it will need to transmit all its UL TBs. There may be a predefined maximum number of transmission opportunities supported by the enhanced EDT. In alternative embodiments, the UE will send a Buffer Status Report (BSR) in Msg3, and the eNB will determine on basis of the BSR how many resource blocks are maximally needed for the transmission of the data, taking into account the possible re-transmission occasions for each TB. In addition, each Physical Uplink Shared Channel (PUSCH) signal transmitted after Msg3 (i.e. UL2, UL3 . . . ) may include an indication as to whether it is the last TB which the UE wants to transmit (e.g. one bit of information indicating either that this is the last TB or that more TBs will follow).

As already explained, in some embodiments, if the MO data exceeds the absolute maximum defined by the max TBS and the max number of transmission opportunities, the UE will transmit a legacy Msg3 (including a request for RRC Connection setup). However, in some alternative embodiments, the UE always transmits all its data using the pre-defined resource allocation pattern.

The UE (sensor 4) will use the same transmission parameters and the same allocation information for the additional transmission opportunities as it used for the first transmission opportunity after the RAR 40 (i.e., the Msg3 41), unless new a Downlink Control Indicator (DCI) is obtained with re-scheduling info (e.g., through DCI blocks 42, 44). In alternative embodiments, the transmission parameters given in the RAR message 404 are used only for the first TB delivered in Msg3, and the pre-defined transmission parameters are applied for additional TBs transmitted in the pre-allocated resources.

During any gaps between consecutive transmission opportunities 41, 43, 46 (in cases where such gaps are non-zero), the UE is required to monitor the common search space of the M-PDCCH (Machine-Type Communication Physical Downlink Control Channel) or N-PDCCH (NB-IOT Physical Downlink Control Channel) according to the predefined settings. New DCI 44 may indicate transmission parameter changes and the need of timing advance change. In addition, the new DCI 44 may contain Hybrid Automatic Repeat Request (HARQ) information pertaining to the transmitted TBs.

The eNB 7 may additionally at any time after Msg3 transmit Physical Downlink Shared Channel (PDSCH) information 45 scheduled via Common Search Space (CSS) and containing, e.g., information for contention resolution and/or Hybrid Automatic Repeat Request (HARQ) feedback information for the UL HARQ processes transmitted prior to this point of time within the enhanced-EDT time frame.

A new type of DCI 42, 44 is defined for enhanced-EDT purposes. It may include the following information:
re-scheduling info for the yet upcoming EDT transmission opportunities
HARQ information for the HARQ processes transmitted during earlier transmission opportunities
Timing Advanced (TA) update information
M-PDCCH/N-PDCCH order (in the case that TA is badly outdated)

A PDCCH order in the new type of DCI 42, 44 may also be used to guide or order the UE (sensor 4) to use different preamble or Random Access Channel (RACH) resources for a subsequent random-access procedure in which the enhanced EDT can take place.

In some embodiments, instead of predefined gaps (e.g., equal intervals) between the up-link blocks 41, 43, 46, a custom schedule could be specified by the eNB 7 or the UE 4 in any appropriate way.

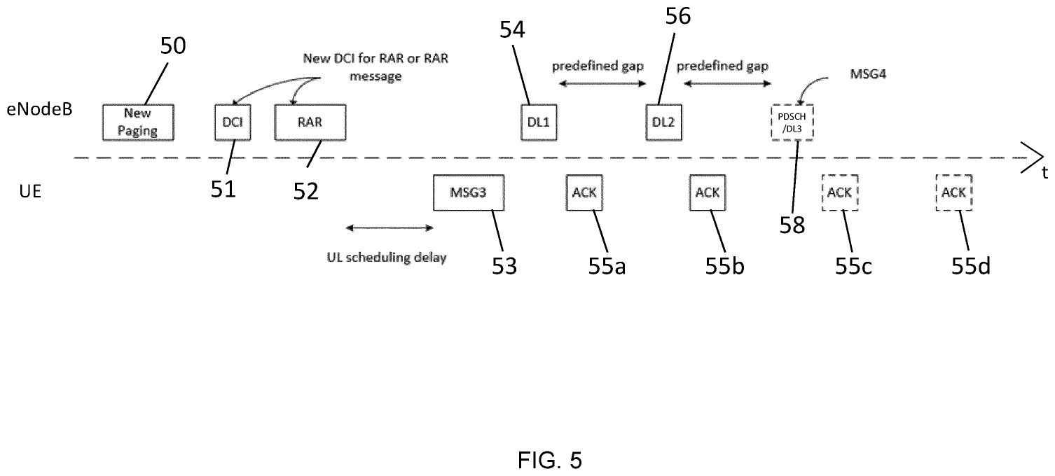

FIGS. 5, 6 and 7 illustrate methods by the eNB 7 may send down-link (DL)/mobile-terminating (MT) data to the UE 4, across one or multiple transport blocks (depending on the length of the data), using novel enhanced-EDT mechanisms. The radio access network 6 may support one or all of these methods.

In some cases, enhanced-EDT for MT data may be started by a novel type of paging message DCI which orders the UE 4 to start a random access procedure with EDT. The MT EDT could, in other respects, be similar to the MO EDT in 3GPP Release 15 or to the above-described extended-EDT, allowing data segmentation also for down-link. In other cases, EDT may be started after a conventional (legacy) paging message by a novel type of EDT DCI monitoring. The new EDT DCI indicates to the UE 4 that EDT or enhanced EDT will follow. A third option is to start EDT or enhanced EDT during the random access procedure, as for MO data in 3GPP Release 14.

In MT EDT, the UE 4 can use legacy HARQ solutions to acknowledge new message types, including data to be received during the random access process. MO and MT EDT data may be mixed and served within the same EDT process with these solutions.

FIG. 5 shows the eNodeB 7 sending a novel paging message 50 which indicates mobile-terminating (MT) EDT resources. The UE 4 monitors for this novel paging group and, thereafter, transmits random access request signal and starts monitoring for a novel EDT DCI 51 for random access response (RAR), and/or for a novel type of random access response (RAR) message 52.

The novel DCI 51 may order the UE 4 to use specific Preamble/RACH resources, and prepare the random access for enhanced-EDT. The preamble may be transmitted after the new paging message 50 in the case of contention-based random access or after the RAR 52 in the case of contention-free random access, in order to support uplink synchronization or timing advance (TA).

When specific Preamble or PRACH resources are used, the DCI for RAR 51 or RAR 52 message may be used to indicate to the UE 4 that this enhanced-EDT solution is in use for downlink. The RAR 52 may include scheduling information for the following data segments 54, 56, 58, or the data segments may be semi-static (i.e., configured by RRC message when the UE is in the RRC connected state), using predefined gaps or predefined transmission pattern similar to the enhanced-MO EDT solution described above. The RAR 52 may also include already some EDT MT data for the UE 4, or the first MT data may be sent in a separate first DL block 54 after a Msg3 53. The UE 4 acknowledges each DL block 54, 56, 58 with an appropriate ACK message 55a, 55b, 55c, 55d. In addition, the UE is expected to monitor a predefined search space for possible DCI-messages; these may, for example, provide scheduling information for the re-transmission of unsuccessfully decoded TBs.

A Msg4 PDSCH block 58, or a new type of message, may be used to indicate that data transmission (consisting of two data blocks, DL1, DL2) is completed. Alternatively, in situations where a known quantity of DL packets are prescheduled, and the amount of TBS is given in a DCI for RAR or RAR message, the block 58 may instead be a final DL block (DL3). Of course, FIG. 5 illustrates only two particular examples, and the number and spacing of the DL blocks can differ in practice.

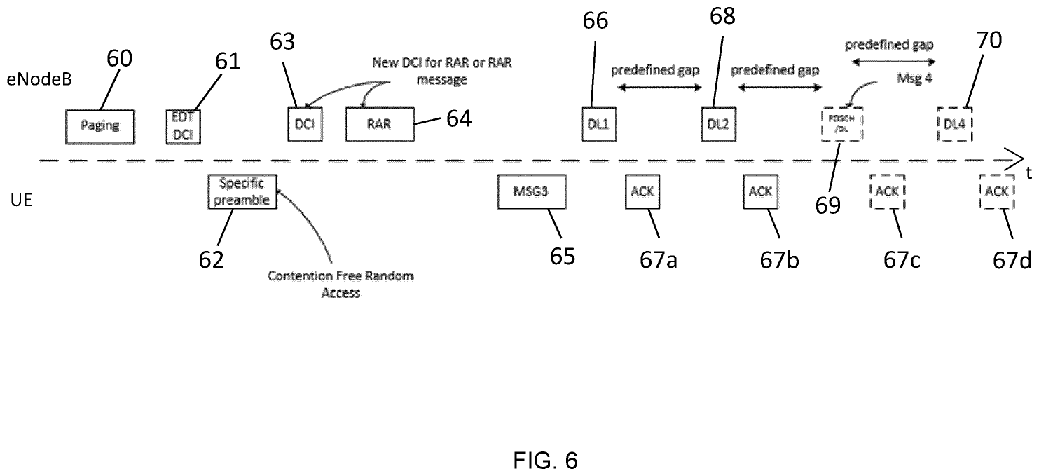

FIG. 6 shows an alternative method for sending MT data. This method may be supported by the same system 1 as the previous method, or it may be used in an alternative set of embodiments.

Here, a conventional LTE paging message 60, of any appropriate kind, is used to indicate to the UE (e.g., sensor 4) that downlink data is coming. If the UE 4 supports the method, it monitors the search space for a novel type of EDT DCI 61 which indicates what random access resources to use. The UE 4 is ordered to use dedicated Preamble/PRACH resources to get its dedicated data. The random access is contention free. A UE-specific preamble 62 may be transmitted after the EDT DCI 61, or after the RAR 64, to support uplink synchronization/timing advance (TA).

When specific Preamble or PRACH resources are used, novel DCI 63 for RAR, or a novel RAR message 64, may be used to indicate to the UE 4 that this enhanced-EDT solution is in use for downlink data. The RAR 64 may include scheduling information for the following data segments 66, 68, 69, 70, or the data segments may be semi-static, having predefined gaps. As with FIG. 5, one or multiple down-link blocks 66, 68, 69, 70 may be sent by the eNodeB 7 after the Msg3 65 from the UE 4. However, in some embodiments, Msg3 65 may be replaced by an ACK/NACK if there is no need for Msg3 related information at this point. (A Msg3 is needed if an MO EDT session is configured at the same time, but necessarily otherwise.) The RAR 64 may itself optionally include the first block of MT data for the UE 4. As before, each down-link block is acknowledged with an ACK 67a-d.

A Msg4 block 69 may be used to indicate the end of the data transmission.

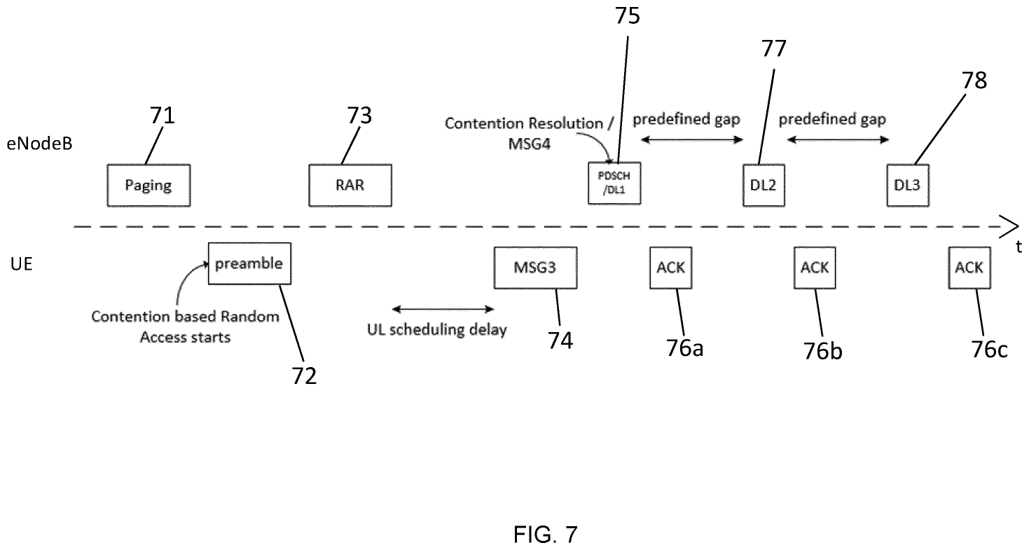

FIG. 7 shows a further alternative for sending one or more blocks of MT data. As with FIG. 6, a conventional paging message 71 may be used to initiate the data exchange.

In this case, conventional contention-based random access is performed, by the UE 4 sending a preamble 72 and receiving an RAR message 73.

After a Msg3 block 74 from the UE 4, the eNB 7 then sends a novel type of Contention Resolution (Msg4) message 75. This encodes:
the UE identifier (ID)
the first segment of down-link (DL) data
re-scheduling information for the upcoming EDT transmission opportunities; and
re-scheduling information to do a new random access, based on contention-free random access, to update the Timing Advance (TADV) and have contention-free resources for the rest of the EDT procedure.

The subsequent DL blocks 77, 78 follow after predefined gaps (or at custom scheduled intervals). Alternatively, in any of the MT EDT solutions described herein, the DL data blocks and relative ACK/NACKs may be transmitted according to some other preconfigured pattern, as disclosed above for MO EDT solutions. Retransmissions of missed data packets may happen after all the prescheduled packets have been received or with DCI monitoring in between the packets. The Contention Resolution message 75 and each following DL block 77, 78 is acknowledged by the UE 4 with a respective ACK 76a-76c.

In every example described above it will be noted that no RRC connection is established, and the UE 4 remains in an RRC idle state, thereby avoiding the additional power consumption that is associated with switching to an RRC connected state. Although the illustrated examples show uni-directional data transfers, it will be appreciated that they may be combined to send one or more up-link data blocks as well as one or more down-link data blocks in the same enhanced-EDT transaction.

It will be appreciated by those skilled in the art that the invention has been illustrated by describing one or more specific embodiments thereof, but is not limited to these embodiments; many variations and modifications are possible, within the scope of the accompanying claims.

1. A method of operating a radio system comprising a radio device and a base station, wherein the radio system is configured for establishing a data connection between the radio device and the base station by performing steps comprising the radio device: sending a random-access request message to the base station; receiving a random-access response message from the base station; sending a connection-establishment request message to the base station; and sending a connection-setup complete message to the base station, the method comprising:
the radio device sending a random-access request message to the base station;
the radio device receiving a random-access response message from the base station; and
thereafter transmitting a plurality of data transport blocks in a first direction between the radio device and the base station, wherein the radio device does not send a connection-setup complete message to the base station between i) receiving the random-access response message and ii) all of the plurality of data transport blocks having been transmitted.

2-15. (canceled)

16. A radio device for communicating with a radio system, the radio system comprising a base station, wherein:
the radio device is configured for establishing a data connection with the base station by performing steps comprising the radio device: sending a random-access request message to the base station; receiving a random-access response message from the base station; sending a connection-establishment request message to the base station; and sending a connection-setup complete message to the base station; and
the radio device is further configured for transmitting a plurality of data transport blocks to the base station, or for receiving a plurality of data transport blocks from the base station, by performing steps comprising: sending a random-access request message to the base station; receiving a random-access response message from the base station; and, thereafter, transmitting or receiving the plurality of data transport blocks, wherein the radio device does not send a connection-setup complete message to the base station between i) receiving the random-access response message and ii) transmitting or receiving all of the plurality of data transport blocks.

17. The radio device of claim 16, configured to support a Machine-Type Communications (MTC) radio protocol.

18. The radio device of claim 16, configured to remain in an idle state while transmitting or receiving the plurality of data transport blocks.

19. The radio device of claim 16, configured to transmit the plurality of data transport blocks to the base station.

20. The radio device of claim 16, configured not to send a connection-establishment request message to the base station between i) receiving the random-access response message and ii) transmitting or receiving all of the plurality of data transport blocks.

21. The radio device of claim 16, configured to receive scheduling information for one or more of the plurality of data transport blocks, contained within the random-access response message.

22. The radio device of claim 16, configured to transmit or receive the plurality of data transport blocks at predetermined intervals that are preconfigured in the radio device.

23. The radio device of claim 16, configured to transmit or receive the plurality of data transport blocks according to scheduling information that is communicated between the radio device and the base station.

24. The radio device of claim 16, configured to transmit the plurality of data transport blocks, and configured to communicate to the base station information representing how much data the radio device will transmit in the plurality of data transport blocks.

25. The radio device of claim 16, configured for i) transmitting the plurality of data transport blocks to the base station and further configured for receiving one or more further data transport blocks from the base station, or ii) receiving the plurality of data transport blocks from the base station and further configured for transmitting one or more further data transport blocks to the base station, after the radio device receives the random-access response message from the base station, wherein the radio device is configured not to send a connection-setup complete message to the base station between i) receiving the random-access response message and ii) all of the one or more further data transport blocks having been transmitted.

26. The radio device of claim 16, configured to send the random-access request message in response to receiving a paging message from the base station.

27. The radio device of claim 16, configured to use common transmission parameters or common allocation information when sending each of the plurality of data transport blocks, unless the radio device receives downlink control information from the base station while transmitting the plurality of data transport blocks.

28. The radio device of claim 16, configured to determine a quantity of data to send to the base station and to determine, based on the quantity of data, whether to establish a data connection with the base station or whether to send the data in one or more data transport blocks without sending a connection-establishment request message to the base station.

29. A method of operating a radio system comprising a radio device and a base station, wherein the radio system is configured for establishing a data connection between the radio device and the base station by performing steps comprising the radio device: sending a random-access request message to the base station; receiving a random-access response message from the base station; sending a connection-establishment request message to the base station; and sending a connection-setup complete message to the base station, the method comprising:
the base station sending a paging message to the radio device;
the radio device, in response to the paging message, sending a random-access request message to the base station;
the radio device receiving a random-access response message from the base station; and
the base station thereafter transmitting one or more data transport blocks to the radio device,
wherein the radio device does not send a connection-setup complete message to the base station between i) receiving the random-access response message and ii) receiving all of the one or more data transport blocks.

30-39. (canceled)

40. A radio device for communicating with a radio system, the radio system comprising a base station, wherein:
the radio device is configured for establishing a data connection with the base station by performing steps comprising the radio device: sending a random-access request message to the base station; receiving a random-access response message from the base station; sending a connection-establishment request message to the base station; and sending a connection-setup complete message to the base station; and
the radio device is further configured for receiving one or more data transport blocks from the base station by performing steps comprising: receiving a paging message from the base station; sending, in response to the paging message, a random-access request message to the base station; receiving a random-access response message from the base station; and, thereafter, receiving the one or more data transport blocks from the base station, wherein the radio device does not send a connection-setup complete message to the base station between i) receiving the random-access response message and ii) receiving all of the one or more of data transport blocks.

41. The radio device of claim 40, wherein the paging message is a paging message as defined in the 3rd Generation Partnership Project (3GPP) Release 15 or earlier.

42. The radio device of claim 40, wherein the paging message instructs the radio device to monitor for the one or more data transport blocks.

43. The radio device of claim 40, wherein the random-access response message or a downlink control indicator message sent by the base station instructs the radio device to prepare to receive the one or more data transport blocks.

44. The radio device of claim 40, configured to receive a plurality of data transport blocks from the base station, and configured not to send a connection-setup complete message to the base station between i) receiving the random-access response message and ii) receiving all of the plurality of data transport blocks.

45. The radio device of claim 40, configured to support a Machine-Type Communications (MTC) radio protocol.

46. The radio device of claim 40, configured to remain in an idle state while transmitting or receiving the plurality of data transport blocks.

47. The radio device of claim 40, configured not to send a connection-establishment request message to the base station between i) receiving the random-access response message and ii) transmitting or receiving all of the plurality of data transport blocks.
